(19) United States
(12) Patent Application Publication
(10) Pub. No.: US 2025/0201903 A1
(43) Pub. Date: Jun. 19, 2025

(54) LITHIUM SECONDARY BATTERY

(71) Applicants: TOYOTA JIDOSHA KABUSHIKI KAISHA, Toyota-shi (JP); TOHOKU UNIVERSITY, Sendai-shi (JP)

(72) Inventors: Daisuke HORIKAWA, Toyota-shi (JP); Hiroyuki YAMAGUCHI, Toyota-shi (JP); Hiroshi TSUBOUCHI, Nagoya-shi (JP); Tetsu ICHITSUBO, Sendai-shi (JP); Hongyi LI, Sendai-shi (JP)

(73) Assignees: TOYOTA JIDOSHA KABUSHIKI KAISHA, Toyota-shi (JP); TOHOKU UNIVERSITY, Sendai-shi (JP)

(21) Appl. No.: 18/915,647

(22) Filed: Oct. 15, 2024

(30) Foreign Application Priority Data
Dec. 14, 2023 (JP) 2023-211385

(51) Int. Cl. H01M 10/0525; H01M 4/134

(52) U.S. Cl. CPC H01M 10/0525; H01M 4/134

(57) ABSTRACT

An object of the present disclosure is then to provide a lithium secondary battery with a lithium alloy as a negative electrode active material, in which the lithium secondary battery is enhanced in capacity retention rate and reduced in resistance value. A lithium secondary battery, wherein the lithium secondary battery comprises a negative electrode current collector layer, a negative electrode active material layer, an electrolyte layer in the listed order, the negative electrode active material layer contains lithium, a first metal element that is taken with lithium to form an alloy, and a second metal element that is taken with lithium to form an alloy, the concentration (atomic %) of the first metal element in a surface facing the electrolyte layer is higher than the concentration (atomic %) of the first metal element in a surface facing the negative electrode current collector layer.

### FIELD

The present disclosure relates to a lithium secondary battery.

### BACKGROUND

Lithium secondary batteries with lithium metals and/or lithium alloys as negative electrode active materials are large in potential difference between negative electrodes and positive electrodes and thus achieve a high output voltage, and have a high theoretical capacity density and thus can be expected to be put into practical use, and the following lithium secondary battery is disclosed.

For example, PTL 1 discloses a lithium secondary battery utilizing a deposition-dissolution reaction of a lithium metal, as the reaction of a negative electrode, in which the negative electrode comprises a negative electrode layer, the negative electrode layer contains an alloy of the lithium metal and a dissimilar metal, as a negative electrode active material, and the element ratio of a lithium element in the alloy in full charge of the lithium secondary battery is 40.00 atomic % or more and 99.97 atomic % or less. According to PTL 1, there can be provided a lithium secondary battery which can be enhanced in capacity retention rate.

### CITATION LIST

### Patent Literature

[0004][PTL 1] Japanese Unexamined Patent Publication (Kokai) No. 2023-103517

### SUMMARY

### Technical Problem

Lithium secondary batteries with lithium metals and/or lithium alloys as negative electrode active materials, while are expected to have excellent battery characteristics, are actually low in capacity retention rate and also high in resistance value. Therefore, such lithium secondary batteries have room for improvement in terms of capacity retention rate and resistance value.

An object of the present disclosure is then to provide a lithium secondary battery with a lithium alloy as a negative electrode active material, in which the lithium secondary battery is enhanced in capacity retention rate and reduced in resistance value.

### Solution to Problem

The present disclosure is to achieve the above object by the following measures.

### Aspect 1

A lithium secondary battery, wherein the lithium secondary battery comprises a negative electrode current collector layer, a negative electrode active material layer, an electrolyte layer, a positive electrode active material layer, and a positive electrode current collector layer in the listed order, the negative electrode active material layer contains lithium, a first metal element that is taken with lithium to form an alloy, and a second metal element that is taken with lithium to form an alloy, the concentration (atomic %) of the first metal element in a surface facing the electrolyte layer is higher than the concentration (atomic %) of the first metal element in a surface facing the negative electrode current collector layer, the concentration (atomic %) of the second metal element in a surface facing the electrolyte layer is lower than the concentration (atomic %) of the second metal element in a surface facing the negative electrode current collector layer, and the first metal element is selected from tin, germanium, antimony, and bismuth.

### Aspect 2

The lithium secondary battery according to Aspect 1, wherein the first metal element is selected from tin, germanium, and antimony.

### Aspect 3

The lithium secondary battery according to Aspect 1 or 2, wherein the second metal element is at least one selected from sodium, magnesium, aluminum, silicon, calcium, zinc, gallium, germanium, strontium, rhodium, palladium, silver, barium, lead, iridium, gold, platinum, and bismuth.

### Aspect 4

The lithium secondary battery according to any one of Aspects 1 to 3, comprising an alloy containing the lithium, the first metal element, and the second metal element.

### Advantageous Effects of Invention

According to the present disclosure, a lithium secondary battery with a lithium alloy as a negative electrode active material is enhanced in capacity retention rate and reduced in resistance value.

### BRIEF DESCRIPTION OF DRAWINGS

FIG. 1 is a schematic view for describing the negative electrode active material layer of the lithium secondary battery of the present disclosure.

FIG. 2 is a schematic view for describing the lithium secondary battery of the present disclosure.

### DESCRIPTION OF EMBODIMENTS

Hereinafter, embodiments of the present disclosure are described in detail. Herein, the present disclosure is not limited to the following embodiments, and can be variously modified and carried out within the gist of the present disclosure. In the description of the drawings, the same symbol is applied to the same element, and the overlapped description is omitted.

In the present disclosure, the “mixture” means a composition which can directly form or further contain any other component to form a positive electrode active material layer or the like. In the present disclosure, the “mixture slurry” means a slurry which contains a dispersion medium in addition to the “mixture”, and thus can be applied and dried to form a positive electrode active material layer or the like.

The lithium secondary battery of the present disclosure may be a liquid-based battery containing an electrolytic solution as an electrolyte layer, or may be a solid-state battery comprising a solid electrolyte layer as an electrolyte layer. In the present disclosure, the “solid-state battery” means a battery with at least a solid electrolyte as an electrolyte, and therefore a combination of a solid electrolyte and a liquid electrolyte may be used as an electrolyte in the solid-state battery. The lithium secondary battery of the present disclosure may be an all-solid-state battery, namely, a battery with only a solid electrolyte as an electrolyte.

### <<Lithium Secondary Battery>>

The lithium secondary battery of the present disclosure comprises
a negative electrode current collector layer, a negative electrode active material layer, an electrolyte layer, a positive electrode active material layer, and a positive electrode current collector layer in the listed order,
the negative electrode active material layer contains lithium, a first metal element that is taken with lithium to form an alloy, and a second metal element that is taken with lithium to form an alloy,
the concentration (atomic %) of the first metal element in a surface facing the electrolyte layer is higher than the concentration (atomic %) of the first metal element in a surface facing the negative electrode current collector layer,
the concentration (atomic %) of the second metal element in a surface facing the electrolyte layer is lower than the concentration (atomic %) of the second metal element in a surface facing the negative electrode current collector layer, and
the first metal element is selected from tin, germanium, antimony, and bismuth.

According to the present disclosure, a lithium secondary battery with a lithium alloy as a negative electrode active material is enhanced in capacity retention rate and reduced in resistance value.

Although the detail is not clear, it is considered that the first metal element is easily alloyed with lithium and is high in affinity with an electrolytic solution. It is also considered that the second metal element is combined with the first metal element and thus hardly swollen even by charge. Without being limited by theory, it is presumed that a negative electrode active material layer 112 containing the first metal element and the second metal element appropriately placed specifically suppresses an increase in specific surface area along with charge and discharge, resulting in an increase in capacity retention rate. It is also presumed that the first metal element to be easily alloyed with lithium is heavily placed in an electrolyte layer-facing surface 112a, to allow lithium to easily enter the negative electrode active material layer 112, resulting in a decrease in resistance value. It is presumed that, particularly in a liquid-based battery comprising an electrolytic solution, the affinity between the negative electrode active material layer and the electrolytic solution is increased to facilitate dissolution/deposition of lithium, resulting in a decrease in resistance value.

FIG. 2 is a schematic view illustrating one aspect of the lithium secondary battery of the present disclosure, but not limited to such a case.

A lithium secondary battery 100 comprises a negative electrode current collector layer 111, a negative electrode active material layer 112, an electrolyte layer 120, a positive electrode active material layer 131, and a positive electrode current collector layer 132 in the listed order, and the negative electrode active material layer has an electrolyte layer-facing surface 112a and a negative electrode current collector layer-facing surface 112b. The negative electrode active material layer 112 contains lithium, a first metal element, and a second metal element. The concentration of the first metal element in the electrolyte layer-facing surface 112a is higher than the concentration of the first metal element in the negative electrode current collector layer-facing surface 112b. The concentration of the second metal element in the electrolyte layer-facing surface 112a is lower than the concentration of the second metal element in the negative electrode current collector layer-facing surface 112b. It is considered that the first metal element is easily alloyed with lithium and is high in affinity with an electrolytic solution. It is also considered that the second metal element is combined with the first metal element and thus hardly swollen even by charge. It is presumed that the negative electrode active material layer 112 containing the first metal element and the second metal element appropriately placed specifically suppresses an increase in specific surface area along with charge and discharge, resulting in an increase in capacity retention rate. It is also presumed that the first metal element to be easily alloyed with lithium is heavily placed in the electrolyte layer-facing surface, to allow lithium to easily enter the negative electrode active material layer, resulting in a decrease in resistance value.

### <Configuration of Lithium Secondary Battery>

The lithium secondary battery of the present disclosure comprises a negative electrode current collector layer, a negative electrode active material layer, an electrolyte layer, a positive electrode active material layer, and a positive electrode current collector layer in the listed order.

### <Negative Electrode Current Collector Layer>

The material used in the negative electrode current collector layer is not particularly limited, and a common negative electrode current collector for lithium secondary batteries can be appropriately selected. Examples of the material used in the negative electrode current collector layer can include Cu, Ni, Cr, Au, Pt, Ag, Al, Fe, Ti, Zn, Co, stainless steel, or a carbon sheet, but not limited to such a case. In particular, the material used in the negative electrode current collector layer may be one containing at least one selected from Cu, Ni and stainless steel or may be one made of a carbon sheet, for example, from the viewpoint of ensuring the reduction resistance and from the viewpoint of hardly alloying with lithium. The negative electrode current collector layer may have any coat layer on the surface thereof for the purpose of, for example, adjustment of the resistance.

The shape of the negative electrode current collector layer is not particularly limited, and examples can include a foil shape, a plate shape, or a mesh shape. In particular, a foil shape is preferred.

The thickness of the negative electrode current collector layer is not particularly limited, and may be 0.1 μm or more, or 1 μm or more, and may be 1 mm or less, or 100 μm or less.

### <Negative Electrode Active Material Layer>

In the lithium secondary battery of the present disclosure, the negative electrode active material layer contains lithium, a first metal element that is taken with lithium to form an alloy, and a second metal element that is taken with lithium to form an alloy.

When the “negative electrode active material layer” is in a charge state, a layer of a lithium alloy of lithium and the first metal element and a lithium alloy of lithium and the second metal element is present as the “negative electrode active material layer”, and when the negative electrode active material layer is in a discharge state, lithium in a lithium alloy of lithium and the first metal element and a lithium alloy of lithium and the second metal element is transferred in the form of a lithium ion, to the positive electrode active material layer, and not the lithium alloy of lithium and the first metal element and the lithium alloy of lithium and the second metal element, but a layer of the first metal element and the second metal element may be present as the “negative electrode active material layer”.

The negative electrode active material layer contains at least the first metal element to be alloyed with lithium and the second metal element to be alloyed with lithium in the negative electrode active material, and may further optionally contain a conductive aid, a binder, a solid electrolyte, and the like. The negative electrode active material layer may contain various other additives. The content of each of the negative electrode active material, the conductive aid, the binder, the solid electrolyte, and the like in the negative electrode active material layer may be appropriately determined depending on the objective battery performance. For example, when the total (total solid content) of the negative electrode active material layer is assumed to be 100% by mass, the content of the negative electrode active material may be 40% by mass or more, 50% by mass or more, 60% by mass or more, and may be 100% by mass or less, or 90% by mass or less.

### (Negative Electrode Active Material)

The first metal element to be alloyed with lithium and the second metal element to be alloyed with lithium are used in the negative electrode active material. The first metal element and the second metal element contained in the negative electrode active material layer are different from each other. The first metal element and the second metal element may or may not be here a combination for formation of an alloy.

In the present disclosure, two metal elements being “different” means that the types of these metal elements are different from each other, and does not mean that the types of these metal elements are the same and, for example, only the content rates of these metal elements are different when a lithium alloy is formed. In the present disclosure, two metal elements being “the same” means that the types of these metal elements are the same as each other, and accordingly also encompasses a case where the types of these metal elements are the same and, for example, only the content rates of these metal elements are different when a lithium alloy is formed.

### (First Metal Element)

The first metal element is selected from tin, germanium, antimony, and bismuth. The first metal element is not particularly limited, and is preferably selected from tin, germanium, and antimony from the viewpoint of the capacity retention rate and the resistance value.

In the lithium secondary battery of the present disclosure, the concentration (atomic %) of the first metal element in the electrolyte layer-facing surface is higher than the concentration (atomic %) of the first metal element in the negative electrode current collector layer-facing surface.

The concentration (atomic %) of the first metal element in the electrolyte layer-facing surface is the amount (number of atoms) of the first metal element based on the total amount (number of atoms) of the first metal element and the second metal element in the electrolyte layer-facing surface. Similarly, the concentration (atomic %) of the first metal element in the negative electrode current collector layer-facing surface is the amount (number of atoms) of the first metal element based on the total amount (number of atoms) of the first metal element and the second metal element in the negative electrode current collector layer-facing surface.

The concentration of the first metal element can be determined by observation with a scanning electron microscope (SEM) and element mapping by energy dispersive X-ray analysis (EDX) of a cross section of a preliminary negative electrode active material layer where the first metal element and the second metal element are film-formed on a surface of the negative electrode active material layer in a discharge state or a negative electrode current collector layer described below. In the present disclosure, “the concentration of the first metal element in the electrolyte layer-facing surface” can be determined as the concentration of the first metal element in the closest layer to the electrolyte layer in division of a cross section of the negative electrode active material layer or the preliminary negative electrode active material layer into equal 30 parts from the electrolyte layer-facing surface to the negative electrode current collector layer-facing surface. Similarly, “the concentration of the first metal element in the negative electrode current collector layer-facing surface” can be determined as the concentration of the first metal element in the closest layer to the negative electrode current collector layer in division of a cross section of the negative electrode active material layer or the preliminary negative electrode active material layer into equal 30 parts from the electrolyte layer-facing surface to the negative electrode current collector layer-facing surface.

The concentration (atomic %) of the first metal element in the electrolyte layer-facing surface is not particularly limited, and may be 2.0 times or more, 2.5 times or more, 3.0 times or more, or 5.0 times or more, and may be 1000 times or less, 100 times or less, or 10 times or less the concentration (atomic %) of the first metal element in the negative electrode current collector layer-facing surface.

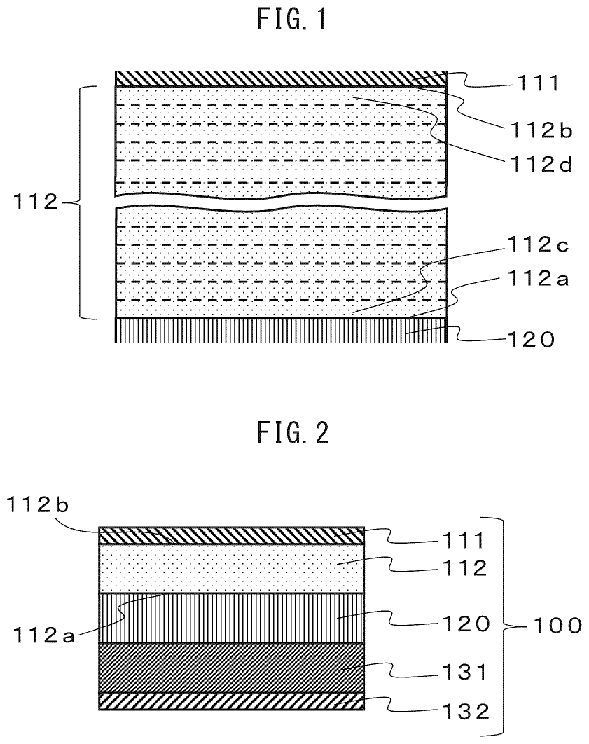

FIG. 1 is a schematic view of a cross section representing one mode of the lithium secondary battery of the present disclosure, and is a schematic view where the negative electrode active material layer is enlarged, but not limited to such a case.

Dotted lines are lines for division of a cross section of a negative electrode active material layer 112 into equal 30 parts from an electrolyte layer-facing surface 112a to a negative electrode current collector layer-facing surface 112b. In the present disclosure, the concentration of the first metal element in the electrolyte layer-facing surface 112a can be determined as the concentration of the first metal element in a closest layer 112c to an electrolyte layer 120. Similarly, the concentration of the first metal element in the negative electrode current collector layer-facing surface 112b can be determined as the concentration of the first metal element in a closest layer 112d to a negative electrode current collector layer 111. The concentration of the first metal element in the closest layer 112c to the electrolyte layer 120 is higher than the concentration of the first metal element in the closest layer 112d to the negative electrode current collector layer 111, namely, the concentration (atomic %) of the first metal element in the electrolyte layer-facing surface 112a is higher than the concentration (atomic %) of the first metal element in the negative electrode current collector layer-facing surface 112b.

### (Second Metal Element)

The second metal element is not particularly limited as long as it is a metal element to be alloyed with lithium.

The second metal element is not particularly limited, and may be at least one selected from sodium, magnesium, aluminum, silicon, calcium, zinc, gallium, germanium, strontium, rhodium, palladium, silver, barium, lead, iridium, gold, platinum, and bismuth.

In the lithium secondary battery of the present disclosure, the concentration (atomic %) of the second metal element in the electrolyte layer-facing surface is lower than the concentration (atomic %) of the second metal element in the negative electrode current collector layer-facing surface.

The concentration (atomic %) of the second metal element in the electrolyte layer-facing surface is the amount (number of atoms) of the second metal element based on the total amount (number of atoms) of the first metal element and the second metal element in the electrolyte layer-facing surface. Similarly, the concentration (atomic %) of the second metal element in the negative electrode current collector layer-facing surface is the amount (number of atoms) of the second metal element based on the total amount (number of atoms) of the first metal element and the second metal element in the negative electrode current collector layer-facing surface.

The concentration of the second metal element can be determined by observation with a scanning electron microscope (SEM) and element mapping by energy dispersive X-ray analysis (EDX) of a cross section of a preliminary negative electrode active material layer where the first metal element and the second metal element are film-formed on the negative electrode active material layer in a discharge state or a negative electrode current collector layer described below. In the present disclosure, “the concentration of the second metal element in the electrolyte layer-facing surface” can be determined as the concentration of the second metal element in the closest layer to the electrolyte layer in division of a cross section of the negative electrode active material layer or the preliminary negative electrode active material layer into equal 30 parts from the electrolyte layer-facing surface to the negative electrode current collector layer-facing surface. Similarly, “the concentration of the second metal element in the negative electrode current collector layer-facing surface” can be determined as the concentration of the second metal element in the closest layer to the negative electrode current collector layer in division of a cross section of the negative electrode active material layer or the preliminary negative electrode active material layer into equal 30 parts from the electrolyte layer-facing surface to the negative electrode current collector layer-facing surface.

The concentration (atomic %) of the second metal element in the electrolyte layer-facing surface is not particularly limited, and may be 0.001 times or more, 0.01 times or more, or 0.1 times or more, and may be 0.2 times or less, 0.3 times or less, 0.4 times or less, or 0.5 times or less the concentration (atomic %) of the second metal element in the negative electrode current collector layer-facing surface.

In FIG. 1 described above and in the present disclosure, the concentration of the second metal element in the electrolyte layer-facing surface 112a can be determined as the concentration of the second metal element in the closest layer 112c to the electrolyte layer 120. Similarly, the concentration of the second metal element in the negative electrode current collector layer-facing surface 112b can be determined as the concentration of the second metal element in the closest layer 112d to the negative electrode current collector layer 111. The concentration of the second metal element in the closest layer 112c to the electrolyte layer 120 is lower than the concentration of the second metal element in the closest layer 112d to the negative electrode current collector layer 111, namely, the concentration (atomic %) of the second metal element in the electrolyte layer-facing surface 112a is lower than the concentration (atomic %) of the second metal element in the negative electrode current collector layer-facing surface 112b.

The negative electrode active material layer is not particularly limited, and may contain an alloy containing lithium, the first metal element and the second metal element.

The negative electrode active material layer may contain any other negative electrode active material than lithium, the first metal element and the second metal element, and the alloy of lithium, the first metal element and the second metal element. Such other negative electrode active material than lithium, the first metal element and the second metal element, and the alloy of lithium, the first metal element and the second metal element is not particularly limited, and examples include a carbon material. Examples of the carbon material include hard carbon, soft carbon, and graphite, but not limited to these cases.

The proportion of lithium, the first metal element and the second metal element, and the alloy of lithium, the first metal element and the second metal element contained in the negative electrode active material layer is not particularly limited, and may be 50% by mass to 100% by mass, 60% by mass to 100% by mass, 70% by mass to 100% by mass, 80% by mass to 100% by mass, or 90% by mass to 100% by mass relative to the negative electrode active material layer.

### (Binder)

The binder is not particularly limited. The binder may be, for example, a material such as polyvinylidene fluoride (PVdF), butadiene rubber (BR), polytetrafluoroethylene (PTFE), or styrene-butadiene rubber (SBR), but not limited thereto. The binder is not particularly limited, and may be used singly or in combination of two or more kinds thereof.

### (Conductive Aid)

The conductive aid is not particularly limited. The conductive aid may be, for example, a vapor-grown carbon fiber (VGCF), acetylene black (AB), Ketjen black (KB), a carbon nanotube (CNT), or a carbon nanofiber (CNF), but not limited thereto. The conductive aid may be, for example, particulate or fibrous, and the size thereof is not particularly limited. The conductive aid is not particularly limited, and may be used singly or in combination of two or more kinds thereof.

### (Solid Electrolyte)

The material of the solid electrolyte is not particularly limited, and may be, for example, a sulfide solid electrolyte, an oxide solid electrolyte, or a polymer electrolyte.

Examples of the sulfide solid electrolyte include a sulfide-based amorphous solid electrolyte, a sulfide-based crystalline solid electrolyte, or an argyrodite-type solid electrolyte, but not limited thereto. Specific examples of the sulfide solid electrolyte can include Li₂S—P₂S₅-based solid electrolyte (Li₇P₃S₁₁, Li₃PS₄, Li₈P₂S₉, or the like), Li₂S—SiS₂, LiI—Li₂S—SiS₂, LiI—Li₂S—P₂S₅, LiI—LiBr—Li₂S—P₂S₅, Li₂S—P₂S₅—GeS₂ (Li₁₃GeP₃S₁₆, Li₁₀GeP₂S₁₂, or the like), LiI—Li₂S—P₂O₅, LiI—Li₃PO₄—P₂S₅, or Li₇₋ₓPS₆₋ₓClₓ; or any combination thereof, but not limited thereto.

Examples of the oxide solid electrolyte include Li₇La₃Zr₂O₁₂, Li₇₋ₓLa₃Zr₁₋ₓNbₓO₁₂, Li₇₋₃ₓLa₃Zr₂AlₓO₁₂, Li₃ₓLa_{2/3-x}TiO₃, Li₁₊ₓAlₓTi₂₋ₓ(PO₄)₃, Li₁₊ₓAlₓGe₂₋ₓ(PO₄)₃, Li₃PO₄, or Li₃₊ₓPO₄₋ₓNₓ(LiPON), but not limited thereto.

The sulfide solid electrolyte and the oxide solid electrolyte may be each glass or crystallized glass (glass ceramics).

Examples of the polymer electrolyte include polyethylene oxide (PEO), polypropylene oxide (PPO), and any copolymer thereof, but not limited thereto.

The shape of the negative electrode active material is not particularly limited, and may be a shape common to negative electrode active materials for lithium secondary batteries. The negative electrode active material may have, for example, a layer shape or a sheet shape. The negative electrode active material may undergo deposition of lithium during charge, and/or may undergo dissolution of lithium during discharge. In this case, the negative electrode active material layer may be a layer composed of the lithium alloy.

The shape of the negative electrode active material layer is not particularly limited, and may be, for example, a sheet-shaped negative electrode active material layer having a substantially flat surface. The thickness of the negative electrode active material layer is not particularly limited, and, for example, may be 0.1 μm or more, 1 μm or more, or 10 μm or more, and may be 200 μm or less, 150 μm or less, or 100 μm or less.

The negative electrode active material layer can be formed with reference to the description of “<Method for producing lithium secondary battery>” below.

### <Electrolyte Layer>

### <Electrolyte Layer-Solid Electrolyte Layer>

The lithium secondary battery of the present disclosure can be a solid-state battery, namely, can have a solid electrolyte layer as the electrolyte layer.

The solid electrolyte layer may contain, if necessary, for example, a binder, in addition to the solid electrolyte.

The solid electrolyte and the binder can be determined with reference to the description of “<Negative electrode active material layer>”.

The thickness of the solid electrolyte layer is not particularly limited, and, for example, may be 0.1 μm or more, 1 μm or more, or 10 μm or more, and may be 2 mm or less, 1 mm or less, or 500 μm or less.

The solid electrolyte layer can be easily formed by, for example, dry or wet molding of an electrolyte mixture containing, for example, the above solid electrolyte and binder.

### <Electrolyte Layer-Separator Layer>

The lithium secondary battery of the present disclosure can be a liquid-based battery, namely, can have an electrolytic solution as the electrolyte layer, in particular, an electrolytic solution retained in a separator layer.

### (Electrolytic Solution)

The electrolytic solution is not particularly limited, and preferably contains a supporting salt and a solvent.

The supporting salt (lithium salt) of an electrolytic solution having lithium ion conductivity is not particularly limited, and examples include an inorganic lithium salt and an organic lithium salt. Examples of the inorganic lithium salt include LiPF₆, LiBF₄, LiClO₄, or LiAsF₆, but not limited to these cases. Examples of the organic lithium salt include LiCF₃SO₃, LiN(CF₃SO₂)₂, LiN(C₂F₅SO₂)₂, LiN(FSO₂)₂, or LiC(CF₃SO₂)₃, but not limited to these cases.

The solvent used in the electrolytic solution is not particularly limited, and examples can include cyclic carbonate or linear carbonate. Examples of the cyclic carbonate can include ethylene carbonate (EC), propylene carbonate (PC), or butylene carbonate (BC), but not limited to such a case. Examples of the linear carbonate include dimethyl carbonate (DMC), diethyl carbonate (DEC), or ethyl methyl carbonate (EMC), but not limited to such a case. The electrolytic solution is not particularly limited, and may be used singly or in combination of two or more kinds thereof.

### (Separator)

The separator is not particularly limited, and a common separator for lithium secondary batteries can be appropriately selected. The separator here used can be, for example, a polyolefin-based, polyamide-based, or polyimide-based non-woven fabric.

### <Positive Electrode Active Material Layer>

The positive electrode active material layer contains at least a positive electrode active material, and may further optionally contain a conductive aid, a solid electrolyte, a binder, and the like. The positive electrode active material layer may contain various other additives. The content of each of the positive electrode active material, the conductive aid, the binder, and the like in the positive electrode active material layer may be appropriately determined depending on the objective battery performance. For example, when the total (total solid content) of the positive electrode active material layer is assumed to be 100% by mass, the content of the positive electrode active material may be 40% by mass or more, 50% by mass or more, 60% by mass or more, and may be 100% by mass or less, or 90% by mass or less.

### (Positive Electrode Active Material)

The material of the positive electrode active material is not particularly limited as long as it can occlude and release a lithium ion. The positive electrode active material may be, for example, lithium cobaltate (LiCoO₂), lithium nickelate (LiNiO₂), lithium manganate (LiMn₂O₄), lithium nickelate/cobaltate/manganate (NCM), LiCO_{1/3}Ni_{1/3}Mn_{1/3}O₂, lithium nickelate/cobaltate/aluminate (NCA; LiNiₓCo_{y}Al_{z}O₂), or Li—Mn spinel having a composition represented by Li₁₊ₓMn_{2-x-y}M_{y}O₄ (M is one or more metal elements selected from Al, Mg, Co, Fe, Ni, and Zn) by substitution with a dissimilar element, but not limited thereto.

The positive electrode active material is not particularly limited, and may have a covering layer. The covering layer is a layer containing a substance which has lithium ion conductive performance, which is low in reactivity with the positive electrode active material and the solid electrolyte, and which does not flow even if contacted with the active material or the solid electrolyte and then can allow the form of the covering layer to be kept. Specific examples of the material constituting the covering layer can include Li₄Ti₅O₁₂ or Li₃PO₄, in addition to LiNbO₃, but not limited thereto.

The shape of the positive electrode active material is not particularly limited as long as it is a shape common to positive electrode active materials for lithium secondary batteries. The positive electrode active material may be, for example, particulate. The positive electrode active material may be a primary particle, or may be a secondary particle of a plurality of primary particles aggregated. The average particle size D₅₀ of the positive electrode active material, for example, may be 1 nm or more, 5 nm or more, or 10 nm or more, and may be 500 μm or less, 100 μm or less, 50 μm or less, or 30 μm or less. The average particle size D₅₀ is here a particle size (median size) at which the cumulative value in a particle size distribution on a volume basis, determined by a laser diffraction/scattering method, is 50%.

The solid electrolyte, the binder, and the conductive aid can be determined with reference to the description of “<Negative electrode active material layer>”.

The shape of the positive electrode active material layer is not particularly limited, and may be, for example, a sheet-shaped positive electrode active material layer having a substantially flat surface. The thickness of the positive electrode active material layer is not particularly limited, and, for example, may be 0.1 μm or more, 1 μm or more, or 10 μm or more, and may be 2 mm or less, 1 mm or less, or 500 μm or less.

### <Positive Electrode Current Collector Layer>

The material used in the positive electrode current collector layer is not particularly limited, and a common positive electrode current collector for lithium secondary batteries can be appropriately selected. Examples of the material used in the positive electrode current collector layer can include Cu, Ni, Cr, Au, Pt, Ag, Al, Fe, Ti, Zn, Co, or stainless steel, but not limited to such a case. The positive electrode current collector layer may have any coat layer on the surface thereof for the purpose of, for example, adjustment of the resistance. The positive electrode current collector layer may be a metal foil or substrate on which the above metal is plated or vapor-deposited.

The shape of the positive electrode current collector layer is not particularly limited, and examples can include a foil shape, a plate shape, or a mesh shape. In particular, a foil shape is preferred.

The thickness of the positive electrode current collector layer is not particularly limited, and may be 0.1 μm or more, or 1 μm or more, and may be 1 mm or less, or 100 μm or less.

The positive electrode active material layer can be produced by applying a known method. For example, the positive electrode active material layer can be easily formed by dry or wet molding of a positive electrode mixture containing various components described above. The positive electrode active material layer may be formed together with the positive electrode current collector layer, or may be formed separately from the positive electrode current collector layer.

### <Shape and the Like of Lithium Secondary Battery>

Examples of the shape of the lithium secondary battery include a coin shape, a laminate shape (pouch battery), a cylindrical shape, or a square shape, but not limited to these cases.

### <Method for Producing Lithium Secondary Battery>

The lithium secondary battery of the present disclosure can be produced by a production method comprising the following steps:
vapor-depositing a first metal element and a second metal element on a surface of a negative electrode current collector layer, thereby forming a preliminary negative electrode active material layer, to obtain a preliminary negative electrode laminate,
stacking the preliminary negative electrode laminate, an electrolyte layer, a positive electrode active material layer that retains lithium, and a positive electrode current collector layer in the listed order, to obtain a preliminary lithium secondary battery, and
subjecting the preliminary lithium secondary battery to a charge operation, thereby transferring lithium from the positive electrode active material layer to the preliminary negative electrode active material layer, to form a negative electrode active material layer and thus obtain a lithium secondary battery.

### (Preliminary Negative Electrode Active Material Layer)

The preliminary negative electrode active material layer is not particularly limited, and can be formed by vapor-depositing the first metal element and the second metal element on a surface of the negative electrode current collector layer. Conditions of a vapor-deposition system (co-vapor deposition) of the first metal element and the second metal element can be adjusted to adjust the concentration of the first metal element and the concentration of the second metal element in the electrolyte layer-facing surface of the preliminary negative electrode active material layer, but not limited to such a case. Similarly, of a vapor-deposition system (co-vapor deposition) of the first metal element and the second metal element can be adjusted to adjust the concentration of the first metal element and the concentration of the second metal element in the negative electrode current collector layer-facing surface of the preliminary negative electrode active material layer, but not limited to such a case.

### (Preliminary Negative Electrode Laminate)

The preliminary negative electrode laminate is not particularly limited, and is a laminate where the negative electrode current collector and the preliminary negative electrode active material layer are stacked in the listed order.

### <Preliminary Lithium Secondary Battery>

The preliminary lithium secondary battery is not particularly limited, and is a laminate where the preliminary negative electrode laminate, the electrolyte layer, the positive electrode active material layer, and the positive electrode current collector layer are stacked in the listed order, namely, a laminate where the negative electrode current collector, the preliminary negative electrode active material layer, the electrolyte layer, the positive electrode active material layer, and the positive electrode current collector layer are stacked in the listed order.

### Examples

The present disclosure is described in further detail with reference to Examples shown below, but the scope of the present disclosure is not limited to these Examples.

### Example 1

### <Production of Preliminary Negative Electrode Laminate>

Tin (Sn) as a first metal element and silver (Ag) as a second metal element were film-formed on one surface of copper (Cu) foil as a preliminary negative electrode current collector, by a vapor-deposition system (co-vapor deposition), to produce a preliminary negative electrode laminate including a negative electrode current collector layer and a preliminary negative electrode active material layer. Here, co-vapor deposition conditions were adjusted to make the film-forming so that 90.1 atomic % of the first metal element and 9.9 atomic % of the second metal element were present in an electrolyte layer-facing surface and 9.9 atomic % of the first metal element and 90.1 atomic % of the second metal element were present in a negative electrode current collector layer-facing surface.

The concentrations of the metal elements were each determined by observation with a scanning electron microscope (SEM) and element mapping by energy dispersive X-ray analysis (EDX) of a cross section of the preliminary negative electrode active material layer. The concentration of the first metal element in the electrolyte layer-facing surface was determined as the concentration of the first metal element in the closest layer to the electrolyte layer in division of a cross section of the preliminary negative electrode laminate into equal 30 parts from the electrolyte layer-facing surface to the negative electrode current collector layer-facing surface. Similarly, the concentration of the first metal element in the negative electrode current collector layer-facing surface was determined as the concentration of the first metal element in the closest layer to the negative electrode current collector layer in division of a cross section of the preliminary negative electrode laminate into equal 30 parts from the electrolyte layer-facing surface to the negative electrode current collector layer-facing surface. The concentration of the second metal element was also determined in the same manner as in the first metal element.

### <Production of Positive Electrode Laminate>

A positive electrode mixture slurry was prepared by mixing LiNi_{1/3}Co_{1/3}Mn_{1/3}O₂ (84 parts by mass) as a positive electrode active material, acetylene black (12 parts by mass) as a conductive aid, PVdF (4 parts by mass) as a binder, and a moderate amount of N-methyl-2-pyrrolidone (NMP) as a dispersion medium. Next, the resulting positive electrode mixture slurry was applied onto aluminum (Al) foil as a positive electrode current collector, and dried, thereby producing a positive electrode laminate in which a positive electrode active material layer was formed on a positive electrode current collector layer.

### <Production of Preliminary Lithium Secondary Battery>

The preliminary negative electrode laminate and the positive electrode laminate were stacked so as to be opposite with a polyolefin film (film thickness 20 μm) as a separator being interposed therebetween, and wound in a spiral manner. Respective terminals were connected to the preliminary negative electrode laminate and the positive electrode laminate wound, and were received in a battery case, 1 M LiPF₆ ethylene carbonate/dimethyl carbonate (1/1(volume ratio)) as an electrolytic solution was injected thereinto, and the battery case was sealed, to produce a preliminary lithium secondary battery.

### <Formation of Lithium Secondary Battery and Evaluation of Capacity Retention Rate Thereof>

The preliminary lithium secondary battery was charged and discharged for 200 cycles with a constant-current (current rate 1 C) system in a cut-off voltage range of 3.3 to 4.2 V at 25° C. The capacity was measured at the first cycle and the 200-th cycle, and the capacity retention rate (Capacity retention rate=(Capacity at 200-th cycle)/(Capacity at first cycle)×100) was calculated. Table 1 shows the results of the capacity retention rate. The capacity retention rate in Table 1 is a relative value in a case where the capacity retention rate of the lithium secondary battery in Comparative Example 1 is 1.00. Here, the preliminary lithium secondary battery was subjected to a charge operation, thereby transferring lithium from the positive electrode active material layer to the preliminary negative electrode active material layer, to form a negative electrode active material layer containing lithium, the first metal element and the second metal element and thus form a lithium secondary battery.

### <Evaluation of Resistance Value of Lithium Secondary Battery>

The lithium secondary battery was adjusted so that the open voltage was 3.70 V. Next, the lithium secondary battery was discharged at −10° C. and a current rate of 5 C for 8 seconds, to measure the voltage drop (ΔV), and the resistance value (current value at a resistance value of ΔV/5 C) was calculated. Table 1 shows the results of the resistance value. The resistance value in Table 1 is a relative value in a case where the resistance value of the lithium secondary battery in Comparative Example 1 is 1.00.

### Comparative Example 1

### <Production of Preliminary Negative Electrode Laminate>

Sn as a first metal element was film-formed on one surface of Cu foil as a preliminary negative electrode current collector by a vapor-deposition system, to produce a preliminary negative electrode laminate including a negative electrode current collector layer and a preliminary negative electrode active material layer.

### <Production of Lithium Secondary Battery, Evaluation of Capacity Retention Rate Thereof, and Evaluation of Resistance Value Thereof>

A lithium secondary battery was produced with a preliminary negative electrode laminate constituted from only a first metal element, by the same method as in Example 1. The capacity retention rate and the resistance value of the lithium secondary battery were evaluated by the same methods as in Example 1. In Examples and Comparative Examples herein, each relative value is shown in a case where the capacity retention rate and the resistance value of the lithium secondary battery in Comparative Example 1 are each 1.00.

### Comparative Example 2

### <Production of Preliminary Negative Electrode Laminate>

Ag as a second metal element was film-formed on one surface of Cu foil as a preliminary negative electrode current collector by a vapor-deposition system, to produce a preliminary negative electrode laminate including a negative electrode current collector layer and a preliminary negative electrode active material layer.

### Comparative Example 3

### <Production of Preliminary Negative Electrode Laminate>

Sn as a first metal element and Ag as a second metal element were film-formed on one surface of Cu foil as a preliminary negative electrode current collector by a vapor-deposition system (co-vapor deposition) so that an alloy was formed, to produce a preliminary negative electrode laminate including a negative electrode current collector layer and a preliminary negative electrode active material layer.

### Examples 2 to 4 and Comparative Example 4

### <Production of Preliminary Negative Electrode Laminate>

Each preliminary negative electrode laminate was produced by the same method as in Example 1 except that each metal described in Table 1 was used as the first metal element.

### Example 5

### <Production of Preliminary Negative Electrode Laminate>

Tin (Sn) as a first metal element and silver (Ag) as a second metal element were film-formed on one surface of Cu foil as a preliminary negative electrode current collector by a vapor-deposition system (co-vapor deposition), then Sn as a first metal element and Ag as a second metal element were film-formed by a vapor-deposition system (co-vapor deposition) so that an alloy was formed, and thereafter tin (Sn) as a first metal element and silver (Ag) as a second metal element were film-formed by a vapor-deposition system (co-vapor deposition), to produce a preliminary negative electrode laminate including a negative electrode current collector layer and a preliminary negative electrode active material layer. Here, co-vapor deposition conditions were adjusted to make the film-forming so that 90.1 atomic % of the first metal element and 9.9 atomic % of the second metal element were present in an electrolyte layer-facing surface and 9.9 atomic % of the first metal element and 90.1 atomic % of the second metal element were present in a negative electrode current collector layer-facing surface.

### <Production of Lithium Secondary Battery, Evaluation of Capacity Retention Rate Thereof, and Evaluation of Resistance Value Thereof>

A lithium secondary battery was produced with the preliminary negative electrode laminate produced in each of Examples 2 to 5 and Comparative Examples 2 to 4, by the same method as in Example 1. The capacity retention rate and the resistance value of the lithium secondary battery in each of Examples 2 to 5 and Comparative Examples 2 to 4 were evaluated by the same methods as in Example 1. The respective results were as shown in Table 1.

TABLE 1

| | First metal element | | | Second metal element | | | | | |
|---|---|---|---|---|---|---|---|---|---|
| | | | Concentration in | | | Concentration in | | Capacity | Resistance |
| | | Concentration | negative electrode | | Concentration | negative electrode | | retention rate | value |
| | | in electrolyte | current collector | | in electrolyte | current collector | Alloy of first | relative to | relative to |
| | | layer-facing | layer-facing | | layer-facing | layer-facing | metal element | Comparative | Comparative |
| | | surface | surface | | surface | surface | and second | Example 1 | Example 1 |
| | Material | [atomic %] | [atomic %] | Material | [atomic %] | [atomic %] | metal element | [—] | [—] |
| Comparative | Sn | — | — | None | — | — | None | 1.00 | 1.00 |
| Example 1 | | | | | | | | | |
| Example 1 | Sn | 90.1 | 9.9 | Ag | 9.9 | 90.1 | None | 1.84 | 0.85 |
| Example 2 | Ge | 90.1 | 9.9 | Ag | 9.9 | 90.1 | None | 1.81 | 0.88 |
| Example 3 | Sb | 90.1 | 9.9 | Ag | 9.9 | 90.1 | None | 1.82 | 0.87 |
| Example 4 | Bi | 90.1 | 9.9 | Ag | 9.9 | 90.1 | None | 1.07 | 1.03 |
| Example 5 | Sn | 90.1 | 9.9 | Ag | 9.9 | 90.1 | Sn/Ag | 2.30 | 0.77 |
| Comparative | None | — | — | Ag | — | — | None | 1.03 | 0.97 |
| Example 2 | | | | | | | | | |
| Comparative | None | — | — | None | — | — | Sn/Ag | 1.08 | 0.99 |
| Example 3 | | | | | | | | | |
| Comparative | Mg | 90.1 | 9.9 | Ag | 9.9 | 90.1 | None | 1.02 | 1.22 |
| Example 4 | | | | | | | | | |

The lithium secondary battery comprising the negative electrode active material layer containing Sn, germanium (Ge), antimony (Sb), or bismuth (Bi) as the first metal element and Ag as the second metal element (Examples 1 to 5) was increased in capacity retention rate and reduced in resistance value as compared with the lithium secondary battery comprising the negative electrode active material layer containing only Sn as the first metal element or the negative electrode active material layer containing only Ag as the second metal element. In particular, the battery comprising the negative electrode active material layer containing Sn, Ge, or Sb as the first metal element (Examples 1 to 3, 5) was favorable in capacity retention rate and resistance value. The lithium secondary battery where the negative electrode active material layer further contained a tin-silver alloy as the alloy of the first metal element and the second metal element (Example 5) was particularly favorable in capacity retention rate and resistance value.

It is considered that the first metal element heavily placed in the electrolyte layer-facing surface is easily alloyed with lithium and is high in affinity with an electrolytic solution. It is also considered that the second metal element heavily placed in the negative electrode current collector layer-facing surface is combined with the first metal element and thus hardly swollen even by charge. It is presumed that a negative electrode active material layer containing the first metal element and the second metal element appropriately placed specifically suppresses an increase in specific surface area along with charge and discharge, resulting in an increase in capacity retention rate. It is also presumed that the first metal element to be easily alloyed with lithium is heavily placed in the electrolyte layer-facing surface, to allow lithium to easily enter the negative electrode active material layer, resulting in a decrease in resistance value. It is further presumed that the affinity between the negative electrode active material layer and the electrolytic solution is increased to facilitate dissolution/deposition of lithium, resulting in a decrease in resistance value.

### Examples 6 to 13 (Influence of Concentration)

### <Production of Preliminary Negative Electrode Laminate>

Each preliminary negative electrode laminate was produced by the same method as in Example 1 except that each concentration described in Table 2 was achieved by adjusting of co-vapor deposition conditions.

### <Production of Lithium Secondary Battery, Evaluation of Capacity Retention Rate Thereof, and Evaluation of Resistance Value Thereof>

A lithium secondary battery was produced with the preliminary negative electrode laminate produced in each of Examples 6 to 13, by the same method as in Example 1. The capacity retention rate and the resistance value of the lithium secondary battery in each of Examples 6 to 13 were evaluated by the same methods as in Example 1. The respective results were as shown in Table 2.

TABLE 2

| | First metal element | | | Second metal element | | | | | |
|---|---|---|---|---|---|---|---|---|---|
| | | | Concentration in | | | Concentration in | Alloy of | Capacity | Resistance |
| | | Concentration | negative electrode | | Concentration | negative electrode | first metal | retention rate | value |
| | | in electrolyte | current collector | | in electrolyte | current collector | element | relative to | relative to |
| | | layer-facing | layer-facing | | layer-facing | layer-facing | and second | Comparative | Comparative |
| | | surface | surface | | surface | surface | metal | Example 1 | Example 1 |
| | Material | [atomic %] | [atomic %] | Material | [atomic %] | [atomic %] | element | [—] | [—] |
| Comparative | Sn | — | — | None | — | — | None | 1.00 | 1.00 |
| Exarople 1 | | | | | | | | | |
| Example 1 | Sn | 90.09 | 9.91 | Ag | 9.91 | 90.09 | None | 1.84 | 0.85 |
| Example 6 | Sn | 69.93 | 9.91 | Ag | 30.07 | 90.09 | None | 1.89 | 0.83 |
| Example 7 | Sn | 59.88 | 9.91 | Ag | 40.12 | 90.09 | None | 1.84 | 0.86 |
| Example 8 | Sn | 50.25 | 9.91 | Ag | 49.75 | 90.09 | None | 1.86 | 0.84 |
| Example 9 | Sn | 90.09 | 0.00 | Ag | 9.91 | 100.00 | None | 1.81 | 0.84 |
| Example 10 | Sn | 90.09 | 9.91 | Ag | 9.91 | 90.09 | None | 1.89 | 0.83 |
| Example 11 | Sn | 90.09 | 30.07 | Ag | 9.91 | 69.93 | None | 1.89 | 0.81 |
| Example 12 | Sn | 90.09 | 40.12 | Ag | 9.91 | 59.88 | None | 1.92 | 0.85 |
| Example 13 | Sn | 90.09 | 49.75 | Ag | 9.91 | 50.25 | None | 1.82 | 0.84 |

In a case where the concentration (atomic %) of the first metal element in the electrolyte layer-facing surface was higher than the concentration (atomic %) of the first metal element in the negative electrode current collector layer-facing surface and the concentration (atomic %) of the second metal element in the electrolyte layer-facing surface was lower than the concentration (atomic %) of the second metal element in the negative electrode current collector layer-facing surface, the capacity retention rate was increased and the resistance value was decreased.

It is presumed that a negative electrode active material layer containing the first metal element and the second metal element appropriately placed specifically suppresses an increase in specific surface area along with charge and discharge, resulting in an increase in capacity retention rate. It is also presumed that the first metal element to be easily alloyed with lithium is heavily placed in the electrolyte layer-facing surface, to allow lithium to easily enter the negative electrode active material layer, resulting in a decrease in resistance value.

### Examples 14 to 30 (Influence of Second Metal Element)

### <Production of Negative Electrode Laminate>

Each preliminary negative electrode laminate was produced by the same method as in Example 1 except that each metal described in Table 3 was used as the second metal element.

### <Production of Lithium Secondary Battery, Evaluation of Capacity Retention Rate Thereof, and Evaluation of Resistance Value Thereof>

A lithium secondary battery was produced with the preliminary negative electrode laminate produced in each of Examples 14 to 30, by the same method as in Example 1. The capacity retention rate and the resistance value of the lithium secondary battery in each of Examples 14 to 30 were evaluated by the same methods as in Example 1. The respective results were as shown in Table 3.

TABLE 3

| | First metal element | | | | | | | | |
|---|---|---|---|---|---|---|---|---|---|
| | | | Concentration in | Second metal element | | | | Capacity | Resistance |
| | | Concentration | negative electrode | | Concentration | negative electrode | | retention rate | value |
| | | in electrolyte | current collector | | in electrolyte | current collector | Alloy of first | relative to | relative to |
| | | layer-facing | layer-facing | | layer-facing | layer-facing | metal element | Comparative | Comparative |
| | | surface | surface | | surface | surface | and second | Example 1 | Example 1 |
| | Material | [atomic %] | [atomic %] | Material | [atomic %] | [atomic %] | metal element | [—] | [—] |
| Comparative | Sn | — | — | None | — | — | None | 1.00 | 1.00 |
| Example 1 | | | | | | | | | |
| Example 1 | Sn | 90.1 | 9.9 | Ag | 9.9 | 90.1 | None | 1.84 | 0.85 |
| Example 14 | Sn | 90.1 | 9.9 | Na | 9.9 | 90.1 | None | 1.90 | 0.85 |
| Example 15 | Sn | 90.1 | 9.9 | Mg | 9.9 | 90.1 | None | 1.89 | 0.82 |
| Example 16 | Sn | 90.1 | 9.9 | Al | 9.9 | 90.1 | None | 1.83 | 0.87 |
| Example 17 | Sn | 90.1 | 9.9 | Si | 9.9 | 90.1 | None | 1.93 | 0.86 |
| Example 18 | Sn | 90.1 | 9.9 | Ca | 9.9 | 90.1 | None | 1.92 | 0.86 |
| Example 19 | Sn | 90.1 | 9.9 | Zn | 9.9 | 90.1 | None | 1.92 | 0.82 |
| Example 20 | Sn | 90.1 | 9.9 | Ga | 9.9 | 90.1 | None | 1.89 | 0.84 |
| Example 21 | Sn | 90.1 | 9.9 | Ge | 9.9 | 90.1 | None | 1.93 | 0.87 |
| Example 22 | Sn | 90.1 | 9.9 | Sr | 9.9 | 90.1 | None | 1.89 | 0.85 |
| Example 23 | Sn | 90.1 | 9.9 | Rh | 9.9 | 90.1 | None | 1.90 | 0.86 |
| Example 24 | Sn | 90.1 | 9.9 | Pd | 9.9 | 90.1 | None | 1.86 | 0.88 |
| Example 25 | Sn | 90.1 | 9.9 | Ba | 9.9 | 90.1 | None | 1.86 | 0.87 |
| Example 26 | Sn | 90.1 | 9.9 | Pb | 9.9 | 90.1 | None | 1.93 | 0.85 |
| Example 27 | Sn | 90.1 | 9.9 | Ir | 9.9 | 90.1 | None | 1.84 | 0.88 |
| Example 28 | Sn | 90.1 | 9.9 | Au | 9.9 | 90.1 | None | 1.88 | 0.86 |
| Example 29 | Sn | 90.1 | 9.9 | Pr | 9.9 | 90.1 | None | 1.84 | 0.84 |
| Example 30 | Sn | 90.1 | 9.9 | Bi | 9.9 | 90.1 | None | 1.84 | 0.82 |

Even in a case where other metal than Ag was used as the second metal element, the capacity retention rate was increased and the resistance value was reduced. It was presumed that the second metal element, even when included various types of metal elements, was combined with the first metal element and thus hardly swollen even by charge, to specifically suppress an increase in specific surface area along with charge and discharge, resulting in an increase in capacity retention rate.

Although preferred embodiments of the lithium secondary battery of the present disclosure are described, it is understood by those skilled in the art that modifications can be made without departing from the claims.

### REFERENCE SIGNS LIST

100 Lithium secondary battery
111 Negative electrode current collector layer
112 Negative electrode active material layer
112a Electrolyte layer-facing surface
112b Negative electrode current collector layer-facing surface
112c Closest layer to electrolyte layer
112d Closest layer to negative electrode active material layer
120 Electrolyte layer
131 Positive electrode active material layer
132 Positive electrode current collector layer

1. A lithium secondary battery, wherein
the lithium secondary battery comprises a negative electrode current collector layer, a negative electrode active material layer, an electrolyte layer, a positive electrode active material layer, and a positive electrode current collector layer in the listed order,
the negative electrode active material layer contains lithium, a first metal element that is taken with lithium to form an alloy, and a second metal element that is taken with lithium to form an alloy,
the concentration (atomic %) of the first metal element in a surface facing the electrolyte layer is higher than the concentration (atomic %) of the first metal element in a surface facing the negative electrode current collector layer,
the concentration (atomic %) of the second metal element in a surface facing the electrolyte layer is lower than the concentration (atomic %) of the second metal element in a surface facing the negative electrode current collector layer, and
the first metal element is selected from tin, germanium, antimony, and bismuth.

2. The lithium secondary battery according to claim 1, wherein the first metal element is selected from tin, germanium, and antimony.

3. The lithium secondary battery according to claim 1, wherein the second metal element is at least one selected from sodium, magnesium, aluminum, silicon, calcium, zinc, gallium, germanium, strontium, rhodium, palladium, silver, barium, lead, iridium, gold, platinum, and bismuth.

4. The lithium secondary battery according to claim 1, comprising an alloy containing the lithium, the first metal element, and the second metal element.
